(19) United States
(12) Patent Application Publication
(10) Pub. No.: US 2013/0022775 A1
(43) Pub. Date: Jan. 24, 2013

(54) TOILET MAT

(71) Applicant: Janice Dye, Detroit, MI (US)

(72) Inventor: Janice Dye, Detroit, MI (US)

(21) Appl. No.: 13/186,417

(22) Filed: Jul. 19, 2011

(51) Int. Cl. B32B 3/02

(52) U.S. Cl. 428/80

(57) ABSTRACT

The present invention is a replaceable and disposable toilet mat that is fittingly placed on a floor area surrounding a toilet to absorb bodily wastes outside the toilet. The toilet mat includes a plastic sheet forming a bottom layer of the toilet mat, a plurality of adhesive pads disposed on the top corners of the plastic sheet and an absorbent fragrance mesh sheet disposed on top of the plastic sheet. The toilet mat also includes apertures disposed on the front portion of the toilet mat to accommodate bolts or screws to secure the toilet mat to the floor, a second absorbent mesh sheet with isopropyl alcohol disposed on top of the absorbent fragrance mesh sheet and a fitted slot disposed in the front center of the toilet mat that fittingly accommodates the toilet.

### TECHNICAL FIELD & BACKGROUND

The present invention generally relates to a toilet mat. More specifically, the invention is a multiple layer fragranced toilet mat.

It is an object of the invention to provide a toilet mat that absorbs moisture and bodily wastes outside the toilet.

It is an object of the invention to provide a toilet mat that has a plurality of layers for relatively better absorbency.

It is an object of the invention to provide a toilet mat that has a fragrance and disinfectant.

What's really needed is a toilet mat that absorbs moisture and bodily wastes that may spatter outside the toilet, that has a fragrance and disinfectant and that has a fragrance and disinfectant.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead perspective view of a toilet mat, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

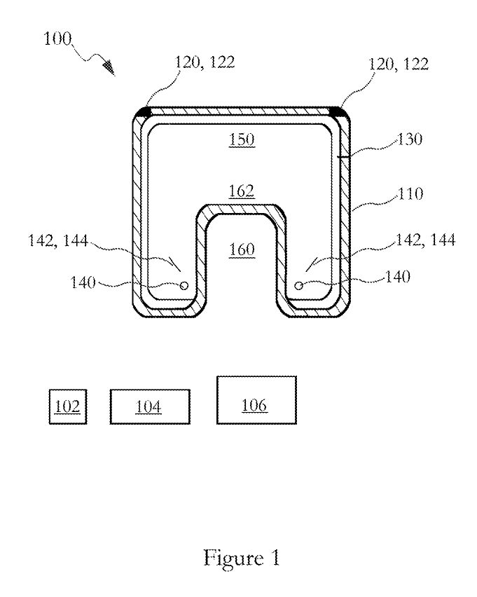

FIG. 1 illustrates an overhead perspective view of a toilet mat 100, in accordance with one embodiment of the present invention.

The toilet mat 100 includes a plastic sheet 110, a plurality of adhesive pads 120, an absorbent fragrance mesh sheet 130, a plurality of apertures 140, an absorbent mesh sheet with isopropyl alcohol 150 and a fitted slot 160. The toilet mat 100 is fittingly placed on a floor area surrounding a toilet to absorb moisture and bodily wastes from outside the toilet.

The plastic sheet 110 is a bottom layer of the toilet mat 100 that keeps waste from seeping through the toilet mat 100 and reaching the floor. The plastic sheet 110 can be any type of suitable plastic and can be separated from the toilet mat 100 and be disposed of and be replaced. The adhesive pads 120 are disposed on the top corners 122 of the plastic sheet 110 that secure the toilet mat 100 to the floor. The absorbent fragrance mesh sheet 130 is disposed on top of the plastic sheet 110. The absorbent fragrance mesh sheet 130 also contains fragrance that can be any suitable fragrance. The apertures 140 are typically disposed on the front portion of the toilet mat 100 and receive a plurality of bolts 142, a plurality of screws 144 or other fasteners to secure the toilet mat 100 to the floor. The absorbent mesh sheet with isopropyl alcohol 150 is disposed on top of the absorbent fragrance mesh sheet 130. The absorbent mesh sheet with isopropyl alcohol 150 can also utilize other suitable types of antiseptic other than or in addition to isopropyl alcohol. The fitted slot 160 is set in the front center 162 of the toilet mat 100 and fittingly accommodates the toilet that the toilet mat 100 is utilized with so that the toilet mat 100 can be positioned to receive as much waste as possible that does not go into the toilet. The toilet mat 100 is approximately 30 inches wide and 28 inches long and can be other suitable sizes. The toilet mat 100 is also available in a variety of scents and is packaged in a 14-count pack 102, a 30-count pack 104 or a 100 count bulk pack 106.

The toilet mat is a sanitary absorbent mat designed to be placed on the floor along the base of the toilet. The toilet mat consists of three layers; a plastic sheet, a heavy absorbent mesh sheet with isopropyl alcohol and an extra top absorbent fragrance mesh sheet.

The two top corners each have an aperture to accommodate a plurality of bolts, screws or other fasteners located at the bottom of the toilet. The toilet mat also has an adhesive attachment on the front of the toilet mat for a non-slip grasp. The toilet mat may be utilized in hospitals, nursing homes and public restrooms and is a great solution for elderly persons experiencing incontinence. The toilet mat's plastic lining prevents damage to floors and makes clean-ups easy by simply disposing the entire mat after use. The toilet mat will be available in a variety of scents and is packaged in a 14-count pack, a 30-count pack or a 100 count bulk pack. The toilet mat features two apertures on the top corners to accommodate a pair of bolts located at the base of the toilet and an adhesive pad at the front of the mat to keep from slipping.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A toilet mat with a front portion and a front center that is fittingly placed on a floor area surrounding a toilet to absorb moisture and a plurality of bodily wastes outside said toilet, comprising:
a plastic sheet with a pair of top corners forming a bottom layer of said toilet mat;
a plurality of adhesive pads disposed on said top corners of said plastic sheet;
an absorbent fragrance mesh sheet disposed on top of said plastic sheet;
a plurality of apertures disposed on said front portion of toilet mat to accommodate a plurality of screws to secure said toilet mat to said floor;
a second absorbent mesh sheet with an antiseptic disposed on top of said absorbent fragrance mesh sheet; and
a fitted slot disposed on said front center of said toilet mat that fittingly accommodates said toilet.

2. The mat according to claim 1, wherein said plastic sheet keeps said bodily wastes from seeping through said toilet mat and reaching said floor area.

3. The mat according to claim 1, wherein said plastic sheet is replaceable and disposable.

4. The mat according to claim 1, wherein said plurality of adhesive pads is a pair of adhesive pads.

5. The mat according to claim 1, wherein said plurality of apertures is a pair of apertures.

6. The mat according to claim 1, wherein said toilet mat is replaceable and disposable.

7. A toilet mat with a front portion and a front center that is fittingly placed on a floor area surrounding a toilet to absorb moisture and a plurality of bodily wastes outside said toilet, comprising:
a plastic sheet with a pair of top corners forming a bottom layer of said toilet mat;
a plurality of adhesive pads disposed on said top corners of said plastic sheet;
an absorbent fragrance mesh sheet disposed on top of said plastic sheet;
a plurality of apertures disposed on said front portion of toilet mat to accommodate a plurality of bolts to secure said toilet mat to said floor;
a second absorbent mesh sheet with isopropyl alcohol disposed on top of said absorbent fragrance mesh sheet; and
a fitted slot disposed on said front center of said toilet mat that fittingly accommodates said toilet.

8. The mat according to claim 7, wherein said plastic sheet keeps said bodily wastes from seeping through said toilet mat and reaching said floor area.

9. The mat according to claim 7, wherein said plastic sheet is replaceable and disposable.

10. The mat according to claim 7, wherein said plurality of adhesive pads is a pair of adhesive pads.

11. The mat according to claim 7, wherein said plurality of apertures is a pair of apertures.

12. The mat according to claim 7, wherein said toilet mat is replaceable and disposable.

13. The mat according to claim 7, wherein said toilet mat is packaged in a 14-count pack, a 30-count pack or a 100 count bulk pack.

14. A replaceable and disposable toilet mat with a front portion and a front center that is fittingly placed on a floor area surrounding a toilet to absorb moisture and a plurality of bodily wastes outside said toilet, comprising:
a plastic sheet with a pair of top corners forming a bottom layer of said toilet mat;
a plurality of adhesive pads disposed on said top corners of said plastic sheet;
an absorbent fragrance mesh sheet disposed on top of said plastic sheet;
a plurality of apertures disposed on said front portion of toilet mat to accommodate a plurality of bolts or a plurality of screws to secure said toilet mat to said floor;
a second absorbent mesh sheet with isopropyl alcohol disposed on top of said absorbent fragrance mesh sheet; and
a fitted slot disposed on said front center of said toilet mat that fittingly accommodates said toilet.

15. The mat according to claim 14, wherein said plastic sheet keeps said bodily wastes from seeping through said toilet mat and reaching said floor area.

16. The mat according to claim 14, wherein said plurality of adhesive pads is a pair of adhesive pads.

17. The mat according to claim 14, wherein said plurality of apertures is a pair of apertures.

18. The mat according to claim 14, wherein said toilet mat is replaceable and disposable.

19. The mat according to claim 14, wherein said toilet mat is packaged in a 14-count pack, a 30-count pack or a 100-count bulk pack.

20. The mat according to claim 14, wherein said mat is approximately 28 inches wide and 30 inches long and can be other suitable sizes.
